(19) United States
(12) Patent Application Publication
(10) Pub. No.: US 2026/0299931 A1
(43) Pub. Date: Oct. 1, 2026

(54) SERVER, METHOD FOR CONTROLLING SERVER, AND COMMUNICATION SYSTEM

(71) Applicant: BROTHER KOGYO KABUSHIKI KAISHA, Nagoya (JP)

(72) Inventor: Hiromu Suzuki, Nagoya (JP)

(21) Appl. No.: 19/630,728

(22) Filed: Mar. 27, 2026

(30) Foreign Application Priority Data
Mar. 28, 2025 (JP) 2025-055874

(51) Int. Cl. G06F 8/65

(52) U.S. Cl. CPC G06F 8/65

(57) ABSTRACT

A server may receive version information from the communication device operating in a first state where a service is not available to the communication device. The server may, in a case where the version information is received from the communication device and the version information satisfies a predetermined condition, send the communication device an update instruction. The server may, after the update instruction has been sent to the communication device, receive, from the communication device, completion information indicating completion of the update of the firmware. The server may, in a case where the completion information is received from the communication device, send the communication device a change instruction for changing a state of the communication device from the first state to a second state where the service is available to the communication device.

### REFERENCE TO RELATED APPLICATION

This application claims priority to Japanese Patent Application No. 2025-055874 filed on Mar. 28, 2025. The entire content of the priority application is incorporated herein by reference.

### BACKGROUND ART

An information processing system is known that includes an image forming device, a flat-rate service server, a host terminal, and a version management server. After contract information has been registered, the flat-rate service server sends a flat-rate service activating instruction to the image forming device. After receiving the flat-rate service activating instruction from the flat-rate service server, the image forming device updates firmware of the image forming device.

### SUMMARY

The disclosure herein provides a novel and useful technology for updating firmware of a communication device at an appropriate time.

A server disclosed herein is configured to provide a service for a communication device. The server may include a controller. The controller may be configured to receive version information related to a version of firmware of the communication device from the communication device operating in a first state where the service is not available to the communication device. The controller may be configured to, in a case where the version information is received from the communication device and the version information satisfies a predetermined condition, send the communication device an update instruction for instructing an update of the firmware. The controller may be configured to, after the update instruction has been sent to the communication device, receive, from the communication device, completion information indicating completion of the update of the firmware. The controller may be configured to, in a case where the completion information is received from the communication device, send the communication device a change instruction for changing a state of the communication device from the first state to a second state where the service is available to the communication device.

According to the configuration above, the server sends the update instruction to the communication device in case the version information received from the communication device satisfies the predetermined condition. Then, the server sends the change instruction to the communication device in response to receiving the completion information from the communication device. Thus, the server can send the change instruction to the communication device at an appropriate time.

Computer-readable instructions for the above server, a non-transitory computer-readable recording medium storing the computer-readable instructions, and a method of controlling the server are also novel and useful. Further, a communication system comprising the server and the communication device is also novel and useful. The non-transitory computer-readable recording medium above may be a single medium or a combination of multiple media.

### BRIEF DESCRIPTION OF DRAWINGS

FIG. 1 illustrates a configuration of a communication system.

FIG. 2 illustrates examples of tables.

FIG. 3 is a sequence diagram of a service subscription process.

FIG. 4 is a sequence diagram continued from FIG. 3.

FIG. 5 is a sequence diagram continued from FIG. 4.

FIG. 6 is a sequence diagram continued from determination of NO in T90 of FIG. 4.

FIG. 7 is a diagram illustrating an example of a home screen including subscription-process-in-progress information.

FIG. 8 is a diagram illustrating an example of a home screen including subscription process completion information

FIG. 9 is a flowchart of a subscription process.

FIG. 10 is a flowchart of an unsupported model process.

FIG. 11 is a diagram illustrating an example of a home screen including subscription process failure information.

FIG. 12 is a sequence diagram for Case A.

FIG. 13 is a sequence diagram for Case B.

FIG. 14 is a sequence diagram continued from FIG. 13.

FIG. 15 is a sequence diagram for Case C.

### DESCRIPTION

### Embodiment

### Configuration of Communication System 2

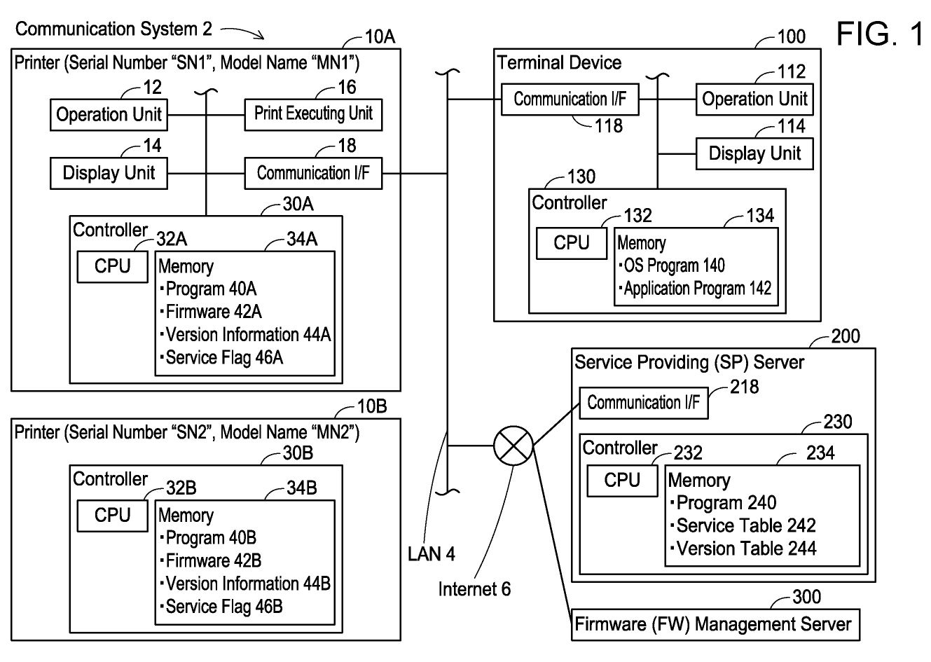

As illustrated in FIG. 1, a communication system 2 comprises a plurality of printers 10A, 10B, a terminal device 100, an SP (service providing) server 200, and an FW (firmware) management server 300. The printers 10A, 10B and the terminal device 100 are connected to a local area network (LAN) 4. The printers 10A, 10B and the terminal device 100 can communicate with each other via the LAN 4. The LAN 4 is connected to the internet 6. The printers 10A, 10B, the terminal device 100, the SP server 200, and the FW management server 300 can communicate with each other via the internet 6.

### Configuration of SP Server 200

The SP server 200 is established on the internet 6 by the vendor of the printers 10A, 10B. Hereinafter, this vendor is simply termed “the vendor”. The SP server 200 may be a single server or a combination of multiple servers. The SP server 200 provides a subscription service. The subscription service allows users to use print paper up to the number of available sheets within a predetermined period at a flat fee. For example, the predetermined period may be one month and the number of available sheets may be 1000 sheets. If the number of actually used print paper within the predetermined period exceeds the number of available sheets, the subscription service charges a total of the flat fee and a fee for the extra print paper used beyond the number of available sheets. The subscription service may include an automatic shipping service. The automatic shipping service is a service of automatically shipping a new cartridge when the remaining amount of ink in the cartridge currently mounted in a printer reaches a predetermined amount or less.

The subscription service includes a plurality of plans. The plurality of plans includes a heavy plan and a light plan. The heavy plan is intended for users who use a relatively large amount of print paper in a printer, i.e., heavy users. The light plan is intended for users who use a relatively small amount of print paper in a printer, i.e., light users. In a modification, the subscription service may not include a plurality of plans.

The SP server 200 comprises a communication I/F (interface) 218 and a controller 230. The communication I/F 218 is connected to the internet 6.

The controller 230 comprises a CPU 232 and a memory 234. The memory 234 comprises a main storage and an auxiliary storage. The main storage includes a RAM and a cache memory, although this is merely an example. The auxiliary storage may be a ROM, a flash memory, a solid state drive (SSD), a hard disk drive (HDD), or a combination thereof, although this is merely an example. The CPU 232 implements various processes according to programs loaded from the auxiliary storage to the main storage. A program 240, a service table 242, and a version table 244 are stored in the auxiliary storage of the memory 234.

### Printers 10A, 10B

The printers 10A, 10B are peripheral devices configured to execute a print function. For example, the printers 10A, 10B are peripheral devices of a personal computer (PC).

The printer 10A has a serial number “SN1” and a model name “MN1”. Serial numbers are identification numbers assigned to printers during manufacture. Model names indicate models of printers. The printer 10A having the model name “MN1” has an automatic notification function in addition to the print function. The automatic notification function is a function of, in response to a change in the state of the printer 10A, sending information corresponding to the change in the state of the printer 10A to a server connected to the printer 10A via an XMPP (Extensible Messaging and Presence Protocol) connection. The change in the state of the printer 10A may include a change from “normal state” to “error state” and an update of firmware 42A. The printer 10A comprises an operation unit 12, a display unit 14, a print executing unit 16, a communication I/F 18, and a controller 30A.

The operation unit 12 is a user interface through which a user can input various information to the printer 10A. The operation unit 12 comprises, for example, a touch screen for displaying software keys, hardware keys, or both of them. The software keys are operation objects. The hardware keys include, for example, buttons or switches. The display unit 14 is a display or a panel for displaying various information. The panel may be or may not be a touch panel. The panel is, for example, a liquid crystal panel or an organic EL panel.

The print executing unit 16 includes a print engine of electrophotographic scheme, inkjet scheme, or thermal scheme. A print engine of inkjet scheme comprises a print head configured to discharge ink in drops. A print engine of electrophotographic scheme comprises, for example, a photoreceptor and an exposure device configured to emit light to expose the photoreceptor to the light. A print engine of thermal scheme comprises a print head configured to generate heat using a heater. A cartridge is mounted to the print executing unit 16. There are a dedicated cartridge and a universal cartridge. The dedicated cartridge can be used when the subscription service is available to a printer. The universal cartridge can be used when the subscription service is not available to the printer. The communication I/F 18 is connected to the LAN 4. The communication I/F 18 may be a wireless I/F or a wired I/F.

The controller 30A comprises a CPU 32A and a memory 34A. The memory 34A comprises a main storage and an auxiliary storage. A program 40A, firmware 42A, version information 44A, and a service flag 46A are stored in the auxiliary storage of the memory 34A. The program 40A is a program for controlling basic operations of the printer 10A. The firmware 42A is a program for controlling the hardware of the printer 10A. The CPU 32A implements various processes according to programs loaded from the auxiliary storage to the main storage. The version information 44A indicates the version of the firmware 42A installed in the printer 10A.

The service flag 46A selectively indicates either “ON” or “OFF”. The service flag 46A indicating “ON” means that the printer 10A is in a service available state where the subscription service is available to the printer 10A. When the printer 10A is in the service available state, the printer 10A can execute printing using the dedicated cartridge. Further, when the printer 10A is in the service available state, the printer 10A sends, for example, the number of print paper used and the remaining amount in the cartridge currently mounted in the printer 10A to the SP server 200 at predetermined time intervals. The service flag 46A indicating “OFF” means that the printer 10A is in a service unavailable state where the subscription service is unavailable to the printer 10A. When the printer 10A is in the service unavailable state, the printer 10A cannot execute printing using the dedicated cartridge. Further, when the printer 10A is in the service unavailable state, the printer 10A does not send the number of print paper used and the remaining amount in the cartridge currently mounted in the printer 10A.

The printer 10B has a serial number “SN2” and a model name “MN2”. The printer 10B having the model name “MN2” does not have the automatic notification function. Thus, even when the state of the printer 10B changes, the printer 10B does not send information corresponding to the change. The printer 10B comprises an operation unit, a display unit, a print executing unit, a communication I/F, and a controller 30B. The operation unit, the display unit, the print executing unit, and the communication I/F of the printer 10B have the same configurations as those of the operation unit 12, the display unit 14, the print executing unit 16, and the communication I/F 18 of the printer 10A, respectively.

The controller 30B comprises a CPU 32B and a memory 34B. The CPU 32B and the memory 34B of the printer 10B have the same configurations as those of the CPU 32A and the memory 34A of the printer 10A, respectively. A program 40B, firmware 42B, version information 44B, and a service flag 46B are stored in the auxiliary storage of the memory 34B. The program 40B, the firmware 42B, the version information 44B, and the service flag 46B in the printer 10B have the same configurations as those of the program 40A, the firmware 42A, the version information 44A, and the service flag 46A in the printer 10A.

### Configuration of Terminal Device 100

The terminal device 100 is a portable device such as a mobile phone, smartphone, PDA, desktop PC, laptop PC, or tablet PC. The terminal device 100 comprises an operation unit 112, a display unit 114, a communication I/F 118, and a controller 130.

The operation unit 112 is a user interface through which the user can input various information to the terminal device 100. The operation unit 112 comprises, for example, a touch screen for displaying software keys, hardware keys, or both of them. The software keys are operation objects. The hardware keys include, for example, buttons or switches. The display unit 114 is a display or a panel for displaying various information. The panel may be or may not be a touch panel. The panel is, for example, a liquid crystal panel or an organic EL panel. The communication I/F 118 is connected to the LAN 4. The communication I/F 118 may be a wireless I/F or a wired I/F.

The controller 130 comprises a CPU 132 and a memory 134. The memory 134 comprises a main storage and an auxiliary storage. An OS program 140 and an app (application) 142 are stored in the auxiliary storage of the memory 134. The OS program 140 is a program for controlling basic operations of the terminal device 100. The app 142 is a program for assisting the user in subscribing to services and is also a program for causing the printers to execute the print function. The CPU 132 implements various processes according to programs loaded from the auxiliary storage to the main storage.

### Configuration of FW Management Server 300

The FW management server 300 is established on the internet 6 by the vendor. The FW management server 300 may be a single server or a combination of multiple servers. The FW management server 300 manages, for multiple types of printers provided by the vendor, firmware for the printers. The FW management server 300 stores firmware for the printer having the model name “MN1” and firmware for the printer having the model name “MN2”, although this is merely an example.

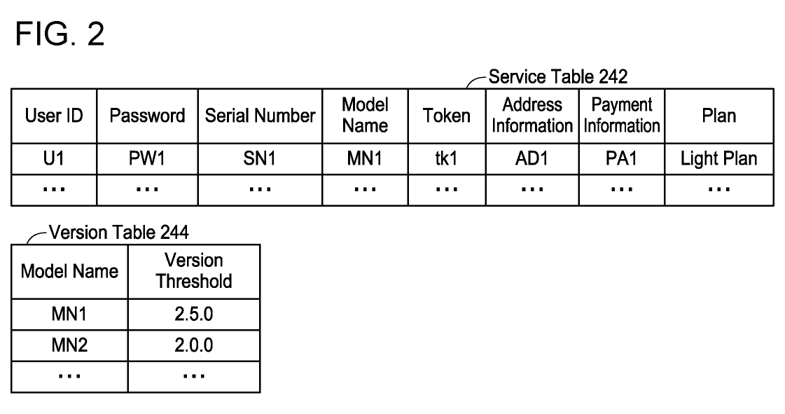

### Tables: FIG. 2

Referring to FIG. 2, the service table 242 and the version table 244 in the SP server 200 are described.

The service table 242 manages information used to provide the subscription service to users. In the service table 242, user IDs, passwords, serial numbers, model names, tokens, address information, payment information, and plans are stored in association with each other. Each user ID is information for identifying a user. Each token is information used for the SP server 200 to authenticate a printer. Each address information indicates a user’s address. Each payment information is used for payment; for example, a credit card number.

The version table 244 manages version thresholds of firmware. A version threshold is information indicating the minimum version required to use the subscription service. In the version table 244, model names and version thresholds are stored in association with each other. Version thresholds associated with respective model names may be different from each other or the same.

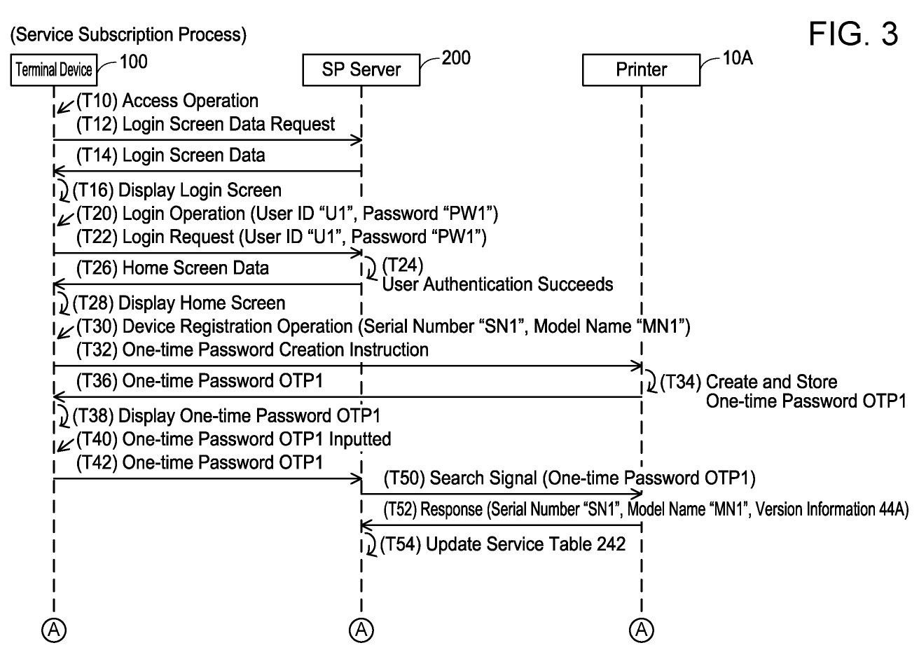

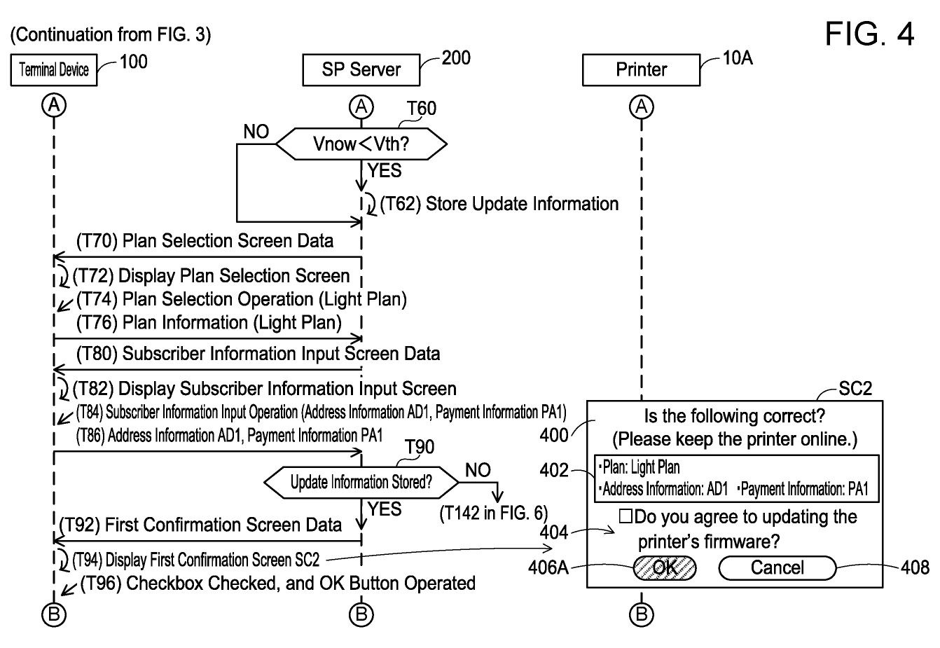

### Service Subscription Process: FIGS. 3 to 6

Referring to FIGS. 3 to 6, a service subscription process is described in which a user of the terminal device 100 subscribes to the subscription service using the printer 10A. In the initial state of the process of FIG. 3, a user ID “U1” and a password “PW1” are stored in association with each other in the memory 234 of the SP server 200, and the user has not subscribed to the subscription service yet. Thus, the service flag 46A in the printer 10A indicates “OFF”. That is, the printer 10A is in the service unavailable state. With respect to FIGS. 3 to 6, steps executed by the CPUs of the respective devices are described with the devices as the subjects of the steps, rather than with the CPUs as the subjects. Further, in the following description, communications between the devices are via their communication I/Fs. Therefore, in the following description, a phrase “via the communication I/F” is omitted when describing communications.

In T10, the user performs an access operation for accessing the SP server 200 on the terminal device 100. In response, the terminal device 100 sends the SP server 200 a login screen data request that requests the SP server 200 to send login screen data representing a login screen in T12. The terminal device 100 receives the login screen data from the SP server 200 in T14 and then displays the login screen on the display unit 114 in T16. The user performs a login operation including input of the user ID “U1” and the password “PW1” on the terminal device 100 in T20. In response, the terminal device 100 sends a login request including the user ID “U1” and the password “PW1” to the SP server 200 in T22.

In response to receiving the login request from the terminal device 100 in T22, the SP server 200 specifies the user ID “U1” and the password “PW1” included in the login request. Since the specified user ID “U1” and password “PW1” are already stored in the memory 234, the SP server 200 determines that the user authentication has succeeded in T24. The SP server 200 then sends home screen data representing a home screen to the terminal device 100 in T26.

The terminal device 100 receives the home screen data from the SP server 200 in T26 and then displays the home screen on the display unit 114 in T28. The home screen includes, for example, a subscription button for subscription to the subscription service. The user performs a device registration operation in T30. The device registration operation includes an operation of the subscription button and an operation of inputting the serial number and the model name of a device to be used for the subscription service. In this process, the device registration operation includes an operation of inputting the serial number “SN1” and the model name “MN1” of the printer 10A. The terminal device 100 specifies the printer 10A having the inputted serial number “SN1” and model name “MN1”. The terminal device 100 then sends a one-time password creation instruction to the specified printer 10A in T32.

In response to receiving the one-time password creation instruction from the terminal device 100 in T32, the printer 10A creates a one-time password OTP1 and stores it in the memory 34A in T34. The printer 10A sends the one-time password OTP1 to the terminal device 100 in T36.

In response to receiving the one-time password OTP1 from the printer 10A in T36, the terminal device 100 displays the one-time password OTP1 on the display unit 114 in T38. The user inputs the one-time password OTP1 to the terminal device 100 in T40. In response, the terminal device 100 sends the one-time password OTP1 to the SP server 200 in T42.

In response to receiving the one-time password OTP1 from the terminal device 100 in T42, the SP server 200 broadcasts a search signal including the one-time password OTP1 in T50. This search signal is a signal for searching for device(s) in which the one-time password included in the search signal is stored.

In response to receiving the search signal from the SP server 200 in T50, the printer 10A specifies the one-time password OTP1 included in the search signal. The printer 10A determines that the specified one-time password is stored in the memory 34A. In this case, the printer 10A sends a response including the serial number “SN1”, the model name “MN1”, and the version information 44A to the SP server 200 in T52. The printer 10B in which the one-time password OTP1 is not stored does not send a response to the search signal in response to receiving the search signal from the SP server 200.

In response to receiving the response from the printer 10A in T52, the SP server 200 updates the service table 242 using the information included in the response. Specifically, the SP server 200 stores the serial number “SN1” and the model name “MN1” included in the response in association with the user ID “U1” in the service table 242.

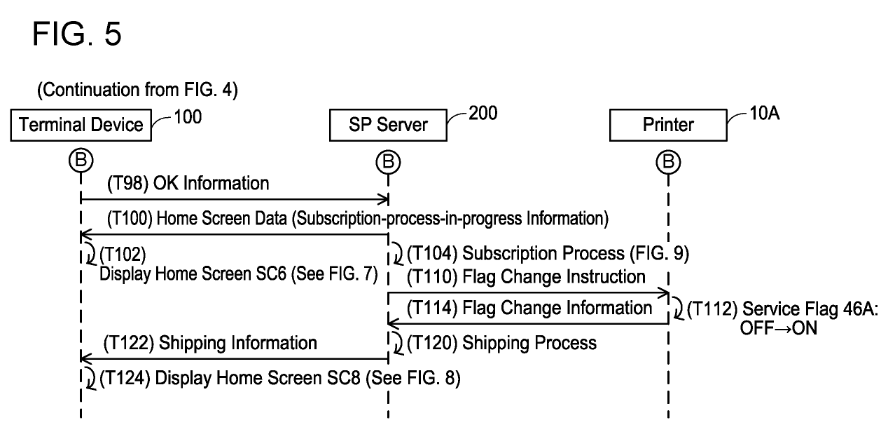

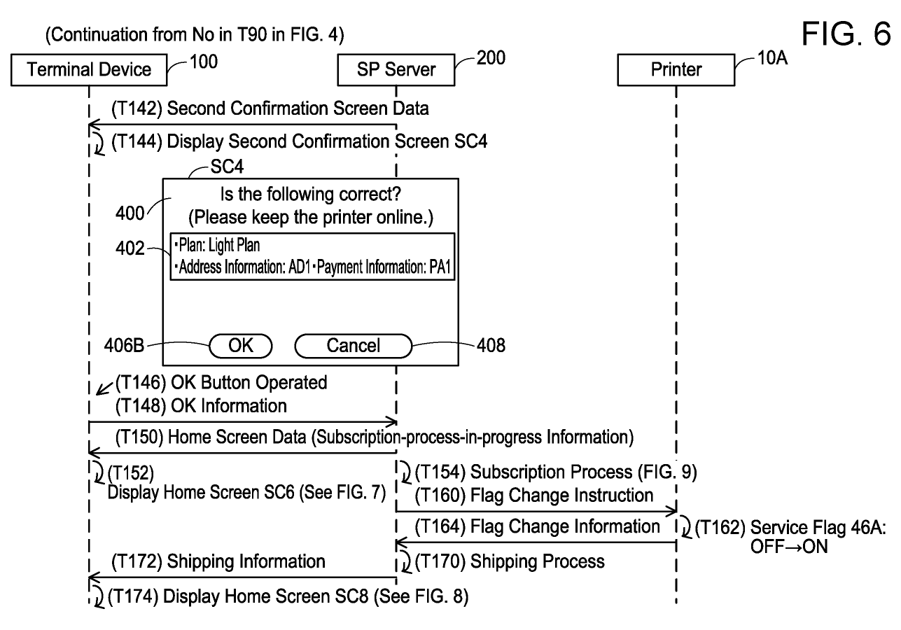

In T60 of FIG. 4, the SP server 200 determines whether a current version Vnow is less than a version threshold Vth. The current version Vnow is the version indicated by the version information 44A included in the response. The SP server 200 specifies the version threshold Vth associated with the model name “MN1” included in the response in the version table 244. In case the current version Vnow is less than the version threshold Vth (YES in T60), the SP server 200 proceeds to T62, while in case the current version Vnow is not less than the version threshold Vth (NO in T60), the SP server 200 skips T62 and proceeds to T70. The SP server 200 stores update information in the memory 234 in T62.

Although not illustrated, the SP server 200 also creates a token tk1, stores the token tk1 in association with the user ID “U1” in the service table 242, and sends the token tk1 to the printer 10A. In response to receiving the token tk1 from the SP server 200, the printer 10A stores the received token tk1 in the memory 34A. The printer 10A then establishes an XMPP connection with the SP server 200 using the token tk1. The XMPP connection is a so-called always-on connection and remains established until the printer 10A is turned off. By using the XMPP connection, the SP server 200 can send requests to the printer 10A across the firewall of the LAN 4 to which the printer 10A belongs, without receiving requests from the printer 10A. However, the SP server 200 may send requests to the printer 10A using a connection other than the XMPP connection. For example, a Hypertext Transfer Protocol Secure (HTTPS) connection may be established between the printer 10A and the SP server 200.

The SP server 200 sends plan selection screen data representing a plan selection screen to the terminal device 100 in T70.

In response to receiving the plan selection screen data from the SP server 200 in T70, the terminal device 100 displays the plan selection screen on the display unit 114 in T72. The plan selection screen is a screen for the user to select a desired plan. The user performs a plan selection operation of selecting the light plan on the terminal device 100 in T74. In response, the terminal device 100 sends plan information indicating the light plan to the SP server 200 in T76.

In response to receiving the plan information from the terminal device 100 in T76, the SP server 200 sends subscriber information input screen data representing a subscriber information input screen to the terminal device 100 in T80.

In response to receiving the subscriber information input screen data from the SP server 200 in T80, the terminal device 100 displays the subscriber information input screen on the display unit 114 in T82. The subscriber information input screen is a screen to which the user inputs subscriber information including address information and payment information. The user performs a subscriber information input operation of inputting address information AD1 and payment information PA1 on the terminal device 100 in T84. In response, the terminal device 100 sends the address information AD1 and the payment information PA1 to the SP server 200 in T86.

In response to receiving the address information AD1 and the payment information PA1 from the terminal device 100 in T86, the SP server 200 determines in T90 whether update information is stored in the memory 234. In case update information is stored in the memory 234 (YES in T90), the SP server 200 proceeds to T92, while in case update information is not stored in the memory 234 (NO in T90), the SP server 200 proceeds to T142 in FIG. 6. The SP server 200 sends first confirmation screen data representing a first confirmation screen SC2 to the terminal device 100 in T92.

In response to receiving the first confirmation screen data from the SP server 200 in T92, the terminal device 100 displays the first confirmation screen SC2 on the display unit 114 in T94. The first confirmation screen SC2 includes a first message 400, a first service information region 402, a check region 404, an “OK” button 406A, and a “Cancel” button 408. The first message 400 includes a message that prompts the user to confirm whether the plan, address information, and payment information are correct. The first message 400 further includes a message that requests the user to maintain the printer online. The first service information region 402 includes the selected plan and the inputted subscriber information. The check region 404 includes a checkbox and a message that asks whether the user agrees to a firmware update. The “OK” button 406A is a button for the user to request subscription to the subscription service. The “OK” button 406A is displayed in an unselectable manner where the button cannot be selected unless the checkbox in the check region 404 is checked. Once the checkbox in the check region 404 is checked, the presentation mode of the “OK” button 406A shifts from the unselectable manner to a selectable manner where the button can be selected. Since the first confirmation screen SC2 includes the check region 404, the user can recognize that a firmware update is necessary to use the subscription service. Further, the user can select whether to update firmware or not.

In T96, the user checks the checkbox in the check region 404 and operates the “OK” button 406A on the terminal device 100. In response, the terminal device 100 sends OK information to the SP server 200 in T98 of FIG. 5. The OK information indicates information for requesting subscription to the subscription service. The terminal device 100 sends NG information to the SP server 200 in case the user operates the “Cancel” button 408.

In response to receiving the OK information from the terminal device 100 in T98, the SP server 200 sends home screen data including subscription-process-in-progress information to the terminal device 100 in T100. In case the SP server 200 receives the NG information from the terminal device 100, the SP server 200 sends the plan selection screen data to the terminal device 100. That is, in case the “Cancel” button 408 is selected by the user, the sequence same as the sequence from T70 to T94 is executed again.

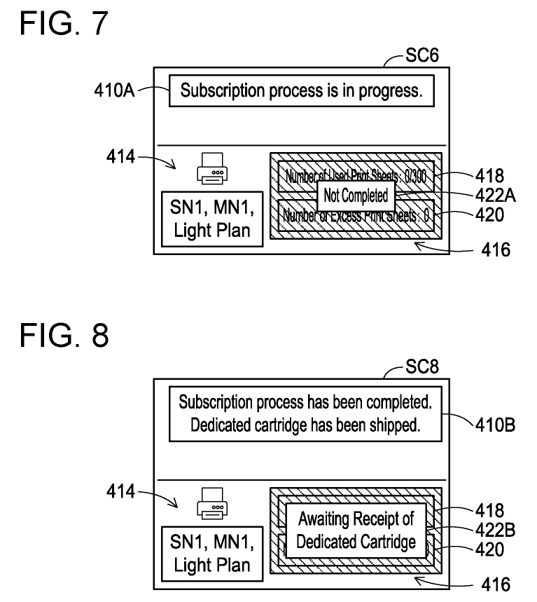

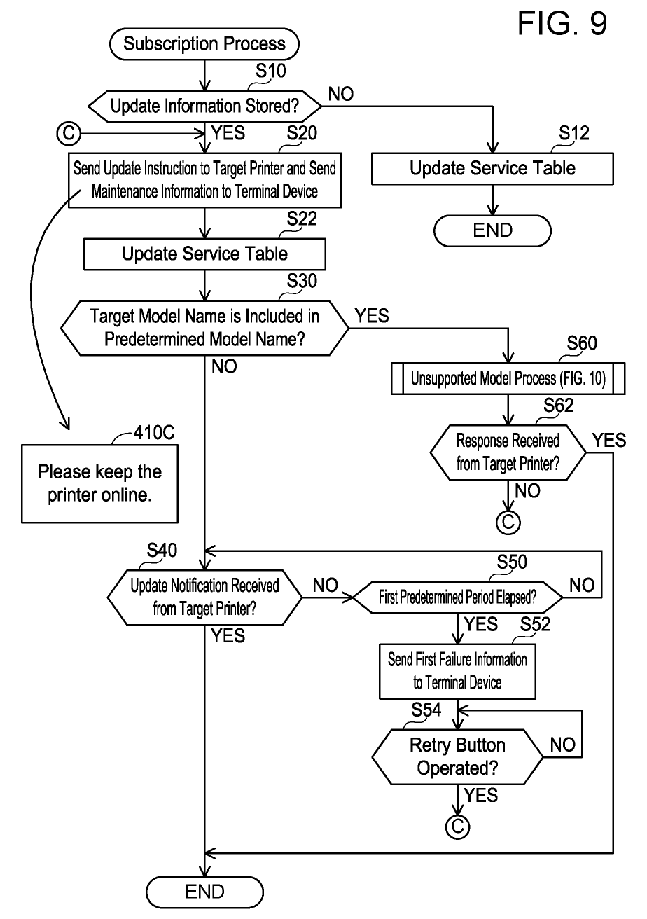

In response to receiving the home screen data from the SP server 200 in T100, the terminal device 100 displays a home screen SC6 on the display unit 114 in T102. As illustrated in FIG. 7, the home screen SC6 includes a first banner 410A, a printer region 414, and a second service information region 416. The first banner 410A includes a message indicating that a subscription process (see FIG. 9) for the user to subscribe to the subscription service is in progress. The message in the first banner 410A corresponds to the subscription-process-in-progress information. The printer region 414 includes the serial number and model name of the printer to be used for the subscription service and the plan desired by the user. The second service information region 416 includes a used paper count region 418 and an excess paper count region 420. The used paper count region 418 includes the number of print paper actually used within the predetermined period and the number of available sheets. The excess paper count region 420 includes the number of excess print paper used within the predetermined period. While the subscription process is in progress, the second service information region 416 further includes a second message 422A indicating that subscription to the subscription service has not been completed yet. When the user has not started using the subscription service yet, the second service information region 416 is displayed in a manner that indicates the subscription service has not been used yet. Here, the user not having started using the subscription service yet means that the dedicated cartridge has not been mounted in the printer. When the user has not started using the subscription service, the second service information region 416 may be hatched, although this is merely an example.

The SP server 200 executes the subscription process (see FIG. 9) in T104 of FIG. 5. Once the subscription process is completed, the SP server 200 sends a flag change instruction to the printer 10A in T110. The flag change instruction is a signal for instructing the printer 10A to change the service flag 46A in the printer 10A from “OFF” to “ON”.

In response to receiving the flag change instruction from the SP server 200 in T110, the printer 10A changes the service flag 46A in the memory 34A from “OFF” to “ON” in T112. As a result, the printer 10A shifts from the service unavailable state to the service available state. The printer 10A sends flag change information indicating that the service flag 46A has been changed to “ON” to the SP server 200 in T114.

In response to receiving the flag change information from the printer 10A in T114, the SP server 200 executes a shipping process in T120. Specifically, the SP server 200 executes a process for shipping the dedicated cartridge to the address indicated by the address information AD1 in the service table 242. The shipping process may include instructing a worker to ship the dedicated cartridge. The SP server 200 sends shipping information indicating that the shipping process has been completed to the terminal device 100 in T122.

In response to receiving the shipping information from the SP server 200 in T122, the terminal device 100 displays a home screen SC8 on the display unit 114 in T124. As illustrated in FIG. 8, the home screen SC8 includes a second banner 410B, a printer region 414, and a second service information region 416. The second banner 410B includes a message indicating that the subscription process (see FIG. 9) has been completed and a message indicating that the dedicated cartridge has been shipped. The latter message in the second banner 410B corresponds to the shipping information. After the shipping process has been completed, the second service information region 416 further includes a third message 422B indicating that the user is awaiting receipt of the dedicated cartridge. As above, user’s subscription to the subscription service is completed.

In case the SP server 200 makes the determination of NO in T90 of FIG. 4, the SP server 200 sends second confirmation screen data representing a second confirmation screen SC4 to the terminal device 100 in T142 of FIG. 6.

In response to receiving the second confirmation screen data from the SP server 200 in T142, the terminal device 100 displays the second confirmation screen SC4 on the display unit 114 in T144. The second confirmation screen SC4 includes a first message 400, a first service information region 402, an “OK” button 406B, and a “Cancel” button 408. The second confirmation screen SC4 is different from the first confirmation screen SC2 in that the former does not include the check region 404 (see FIG. 4). The second confirmation screen SC4 is also different from the first confirmation screen SC2 in that the “OK” button 406B is displayed in the selectable manner in the second confirmation screen SC4. The “OK” button 406B is a button for the user to request subscription to the subscription service. The user operates the “OK” button 406B on the terminal device 100 in T146. In response, the terminal device 100 sends OK information to the SP server 200 in T148.

T152, T154, T160 to T164, and T170 to T174 are the same as T102, T104, T110 to T114, and T120 to T124 in FIG. 5, respectively.

### Subscription Process: FIG. 9

Referring to FIG. 9, the subscription process executed by the CPU 232 of the SP server 200 in T104 of FIG. 5 and T154 of FIG. 6 is described. The CPU 232 executes the process of FIG. 9 in response to receiving the OK information from the terminal device 100. Hereinafter, the user ID, password, plan information, address information, and payment information that have been received from the terminal device 100 before the subscription process is executed are referred to as the target user ID, target password, target plan information, target address information, and target payment information, respectively. Further, the serial number and model name that have been received from the printer before the subscription process is executed and the printer having the serial number are referred to as the target serial number, target model name, and target printer, respectively. At the start of the subscription process, the target user ID, target password, target serial number, and target model name are already stored in association with each other in the service table 242.

In S10, the CPU 232 determines whether update information is stored in the memory 234. That is, the CPU 232 determines whether the current version Vnow is less than the version threshold Vth. In case update information is stored in the memory 234 (YES in S10), the CPU 232 proceeds to S20, while in case update information is not stored in the memory 234 (NO in S10), the CPU 232 proceeds to S12.

In S12, the CPU 232 updates the service table 242. Specifically, the CPU 232 stores the plan indicated by the target plan information, the target address information, and the target payment information in association with the target serial number in the service table 242. After completing S12, the CPU 232 ends the process of FIG. 9. This configuration allows for a reduction in time required for the subscription process compared to a configuration where a sequence from later-described S20 is executed even after the determination of NO has been made in S10.

In S20, the CPU 232 sends an update instruction to the target printer. The update instruction is a signal for instructing an FW update. In response to receiving the update instruction from the SP server 200, the target printer sends an FW request including the target model name to the FW management server 300. The FW request is a signal that requests the FW management server 300 to send the latest FW for the target model name. As a result, the target printer receives the latest FW (i.e., update FW) from the FW management server 300. The target printer then updates the FW of the target printer using the update FW.

The CPU 232 further sends maintenance information to the terminal device 100 in S20. In response to receiving the maintenance information from the SP server 200, the terminal device 100 displays a third banner 410C over the home screen. The third banner 410C includes a message that requests the user to maintain the target printer in an online state. This prevents the user from changing the target printer from the online state to an offline state.

S22 is the same as S12.

In S30, the CPU 232 determines whether the target model name is included in a predetermined model name. The predetermined model name includes one or more model names of unsupported printers. In case the target model name is included in the predetermined model name (YES in S30), the CPU 232 proceeds to S60, while in case the target model name is not included in the predetermined model name (NO in S30), the CPU 232 proceeds to S40.

In S40, the CPU 232 monitors whether an update notification indicating that the FW update has been completed is received from the target printer. In case the update notification is received from the target printer, the CPU 232 makes determination of YES in S40 and then ends the process of FIG. 9.

Simultaneously with the monitoring of S40, the CPU 232 monitors in S50 whether a first predetermined period has elapsed since the update instruction was sent to the target printer. In case the first predetermined period has elapsed since the update instruction was sent to the target printer, the CPU 232 makes determination of YES in S50 and proceeds to S52.

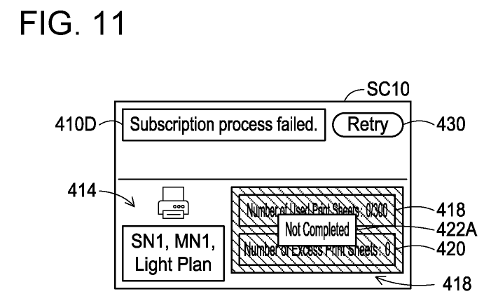

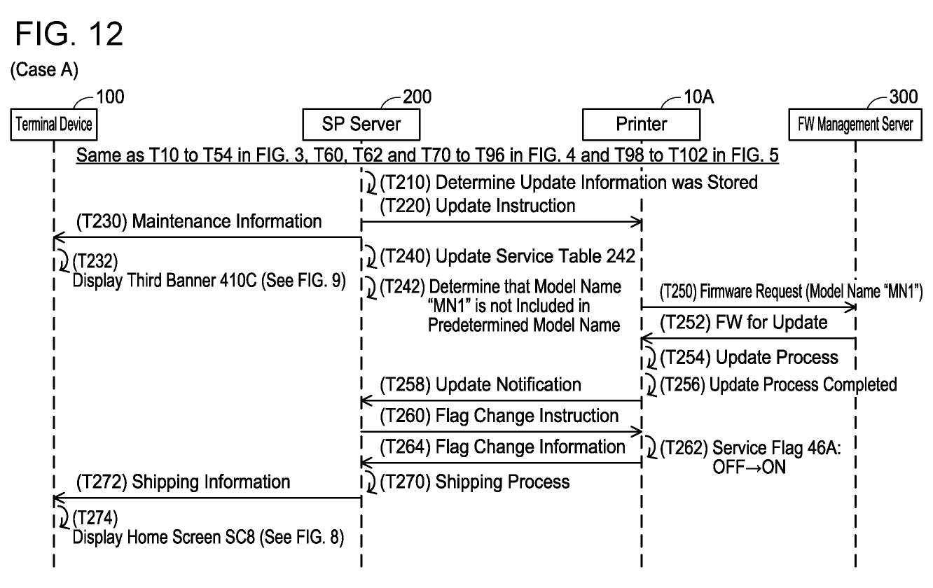

In S52, the CPU 232 sends first failure information indicating that the subscription process has failed to the terminal device 100. In response to receiving the first failure information from the SP server 200, the terminal device 100 displays a home screen SC10 on the display unit 114 as illustrated in FIG. 11. The home screen SC10 is the same as the home screen SC6 illustrated in FIG. 7 except that the former includes a fourth banner 410D and a “Retry” button 430. The fourth banner 410D includes a message indicating that the subscription process has failed. The message in the fourth banner 410D corresponds to the first failure information.

In S54 of FIG. 9, the CPU 232 monitors whether the “Retry” button 430 is operated. In case the “Retry” button 430 is operated, the CPU 232 makes determination of YES in S54 and returns to S20.

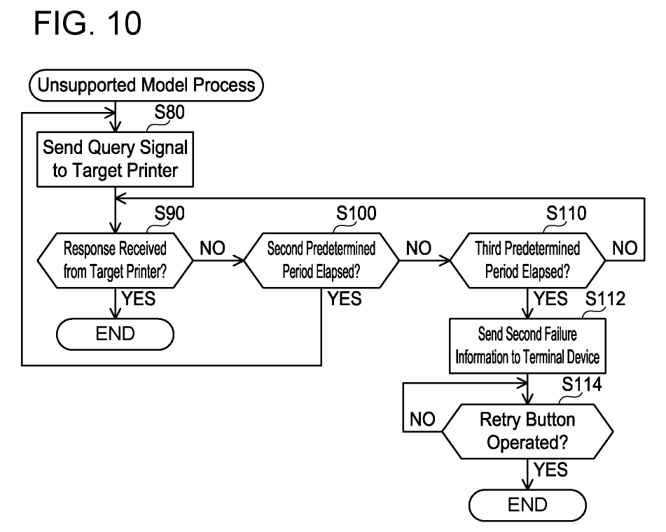

In case the CPU 232 makes determination of NO in S30, the CPU 232 executes an unsupported model process (see FIG. 10) in S60. The unsupported model process is executed to determine whether a firmware update in the target printer of unsupported model has been completed.

In S62, the CPU 232 determines whether a response has been received from the target printer. This response received from the target printer is detailed later. In case a response has been received from the target printer (YES in S62), the CPU 232 ends the process of FIG. 9, while in case a response has not been received from the target printer (NO in S62), the CPU 232 returns to S20.

### Unsupported Model Process: FIG. 10

Referring to FIG. 10, the unsupported model process executed in S60 of FIG. 9 is described.

In S80, the CPU 232 sends the target printer a query signal to query whether the firmware update in the target printer has been completed. The target printer sends a response to the query signal to the SP server 200 in case the firmware update has been completed after the update instruction was received from the SP server 200. That is, this response is a signal indicating the completion of firmware update. This response is the same as the response in S62 of FIG. 9.

The CPU 232 determines in S90 whether the response to the query signal has been received from the target printer. In case the response has been received from the target printer, the CPU 232 makes determination of YES in S90 and then ends the process of FIG. 10.

Simultaneously with the monitoring in S90, the CPU 232 also determines in S100 whether a second predetermined period has elapsed since the query signal was sent to the target printer. In case the second predetermined period has elapsed since the query signal was sent to the target printer, the CPU 232 makes determination of YES in S100 and then returns to S80.

Simultaneously with the monitoring in S90 and the monitoring in S100, the CPU 232 also determines in S110 whether a third predetermined period has elapsed since the query signal was sent to the target printer. The third predetermined period is greater than the second predetermined period. In case the third predetermined period has elapsed since the query signal was sent to the target printer, the CPU 232 makes determination of YES in S110 and proceeds to S112.

In S112, the CPU 232 sends second failure information indicating a failure of the subscription process to the terminal device 100. In case the terminal device 100 receives the second failure information from the SP server 200, the terminal device 100 displays a home screen SC10 (see FIG. 11) on the display unit 114.

In S114, the CPU 232 monitors whether the “Retry” button 430 is operated. In case the “Retry” button 430 is operated, the CPU 232 makes determination of YES in S114 and then ends the process of FIG. 10. With the configuration above, the CPU 232 resends a query signal to the target printer each time the second predetermined period elapses from when the previous query signal was sent, until the third predetermined period elapses since the CPU 232 first sent the query signal to the target printer.

The determination of YES in S62 of FIG. 9 means that the process of FIG. 10 ends in response to the determination of YES in S90 of FIG. 10. Further, the determination of NO in S62 of FIG. 9 means that the process of FIG. 10 ends in response to the determination of YES in S114 of FIG. 10.

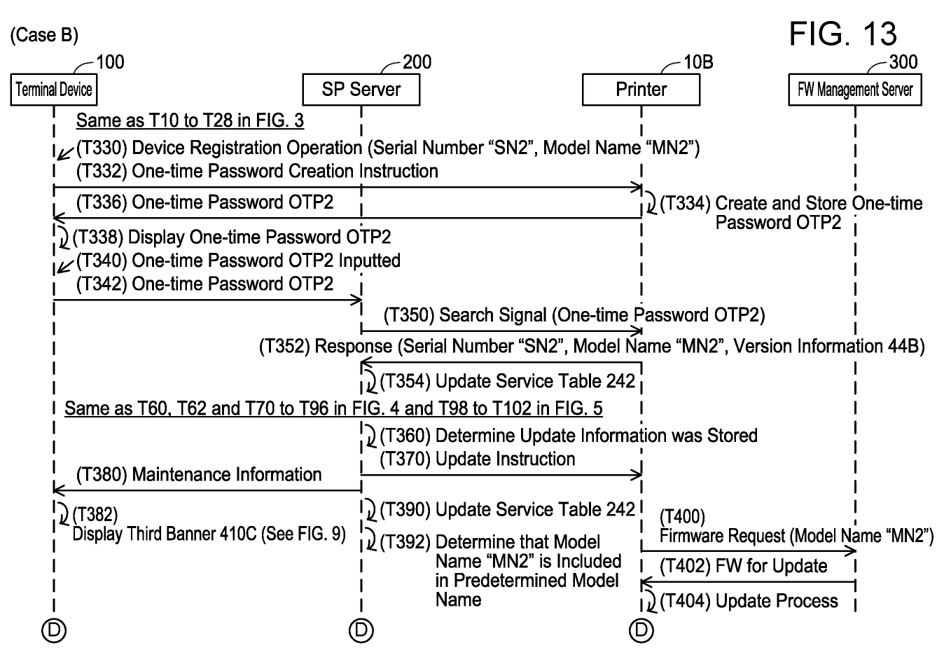

### Specific Cases: FIGS. 12 to 14

Referring to FIGS. 12 to 14, specific cases implemented by the communication system 2 according to this embodiment are described. With respect to FIGS. 12 to 14, steps executed by the CPUs of the respective devices are described with the devices as the subjects of the steps, rather than with the CPUs as the subjects.

### Case A: FIG. 12

Referring to FIG. 12, Case A is described. In Case A, the user subscribes to the subscription service using the printer 10A. The initial state of Case A is the same as the initial state of the service subscription process illustrated in FIGS. 3 to 5. Further, the current version Vnow “1.5.0” of the firmware 42A in the printer 10A is less than the version threshold Vth “2.5.0” for the printer 10A.

First, the same steps as T10 to T54 in FIG. 3, T60, T62, T70 to T96 in FIG. 4, and T98 to T102 in FIG. 5 are executed between the printer 10A, the terminal device 100, and the SP server 200. In T60, the SP server 200 determines that the current version Vnow “1.5.0” is less than the version threshold Vth “2.5.0”.

The SP server 200 determines in T210 that update information is stored in the memory 234 (YES in S10 of FIG. 9). Then, the SP server 200 sends an update instruction to the printer 10A in T220 (S20) and then sends maintenance information to the terminal device 100 in T230. In response to receiving the maintenance information from the SP server 200 in T230, the terminal device 100 displays the third banner 410C over the home screen in T232.

The SP server 200 updates the service table 242 in T240. Specifically, the SP server 200 stores the plan “light plan”, the address information AD1, and the payment information PA1 in association with the serial number “SN1” in the service table 242. The SP server 200 determines in T242 that the model name “MN1” is not included in the predetermined model name (NO in S30). In this case, the SP server 200 executes S40 and S50 in FIG. 9 without sending a query signal to the printer 10A.

In response to receiving the update instruction from the SP server 200 in T220, the printer 10A sends an FW request including the model name “MN1” to the FW management server 300 in T250. The printer 10A receives update FW for the model name “MN1” from the FW management server 300 in T252. The printer 10A executes an update process to update the firmware 42A using the received update FW in T254. During the update process, the printer 10A is rebooted. The printer 10A determines in T256 that the update process has been completed and then sends an update notification to the SP server 200 in T258.

In response to receiving the update notification from the printer 10A in T258 (YES in S40), the SP server 200 ends the subscription process of FIG. 9. A sequence from T260 to T274 is the same as the sequence from T110 to T124 in FIG. 5.

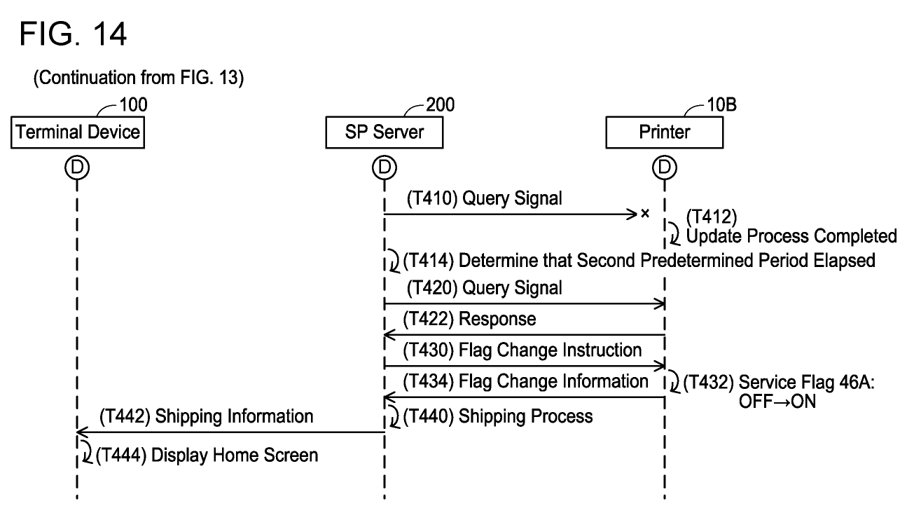

### Case B: FIGS. 13 and 14

Referring to FIGS. 13 and 14, Case B is described. In Case B, the user subscribes to the subscription service using the printer 10B. The initial state of Case B is the same as the initial state of the service subscription process illustrated in FIGS. 3 to 5. Further, the current version Vnow “1.5.0” of the firmware 42B in the printer 10B is less than the version threshold Vth “2.0.0” for the printer 10B.

First, the same steps as T10 to T28 in FIG. 3 are executed between the terminal device 100 and the SP server 200.

In T330, the user performs a device registration operation including input of the serial number “SN2” and the model name “MN2” of the printer 10B on the terminal device 100. In response, the terminal device 100 sends a one-time password creation instruction to the printer 10B having the inputted serial number “SN2” in T332. A sequence from T334 to T350 is the same as the sequence from T34 to T50 in FIG. 3 except that the printer 10B and a one-time password OTP2 are used instead of the printer 10A and the one-time password OTP1.

In response to receiving the search signal from the SP server 200 in T350, the printer 10B determines that the one-time password OTP2 included in the search signal is stored in the memory 34B. In this case, the printer 10B sends a response including the serial number “SN2”, the model name “MN2”, and the version information 44B to the SP server 200 in T352.

In response to receiving the response from the printer 10B in T352, the SP server 200 updates the service table 242 using the information included in the response. Specifically, the SP server 200 stores the serial number “SN2” and the model name “MN2” included in the response in association with the user ID “U1” in the service table 242.

Then, the same steps as T60, T62, T70 to T96 in FIG. 4 and T98 to T102 in FIG. 5 are executed between the printer 10B, the terminal device 100, and the SP server 200. Before executing T60 of FIG. 4, the SP server 200 specifies the version threshold Vth “2.0.0” associated with the model name “MN2” in the version table 244. Then, the SP server 200 determines that the current version Vnow “1.5.0” is less than the version threshold Vth “2.0.0” (YES in T60).

The SP server 200 determines in T360 that update information is stored in the memory 234 (YES in S10 of FIG. 9). In this case, the SP server 200 sends an update instruction to the printer 10B in T370 (S20) and then sends maintenance information to the terminal device 100 in T380. T382 is the same as T232 in FIG. 12.

The SP server 200 updates the service table 242 in T390. Specifically, the SP server 200 stores the plan “light plan”, the address information AD1, and the payment information PA1 in association with the serial number “SN2” in the service table 242. The SP server 200 determines in T392 that the model name “MN2” is included in the predetermined model name (YES in S30). In this case, the SP server 200 executes the unsupported model process illustrated in FIG. 10.

In response to receiving the update instruction from the SP server 200 in T370, the printer 10B sends an FW request including the model name “MN2” to the FW management server 300 in T400. The printer 10B receives update FW for the model name “MN2” from the FW management server 300 in T402. The printer 10B executes an update process to update the firmware 42B using the received update FW in T404.

As illustrated in FIG. 14, the SP server 200 sends a first query signal to the printer 10B in T410 while the printer 10B is executing the update process (S80 in FIG. 10). The printer 10B is configured not to receive signals from external devices while executing the update process. Therefore, the SP server 200 does not receive a response to the query signal from the printer 10B. The update process in the printer 10B is completed in T412. The SP server 200 determines in T414 which is after T412 that the second predetermined period has elapsed since the query signal was sent (YES in S100). In this case, the SP server 200 resends a query signal to the printer 10B in T420 (S80).

In response to receiving the query signal from the SP server 200 in T420, the printer 10B sends a response to the query signal to the SP server 200 in T422.

In response to receiving the response from the printer 10B in T422 (YES in S90, YES in S62 in FIG. 9), the SP server 200 ends the subscription process of FIG. 9. A sequence from T430 to T444 is the same as the sequence from T260 to T274 in FIG. 12 except that the printer 10B is used instead of the printer 10A. The printer 10B changes the service flag 46B from “OFF” to “ON” in T432. As a result, the printer 10B shifts from the service unavailable state to the service available state.

Advantageous Effects of Cases A and B

As illustrated in FIG. 12, the SP server 200 updates the service table 242 after sending the update instruction to the printer 10A (T240). Further, the SP server 200 sends the flag change instruction to the printer 10A (T260) after completing the update of the service table 242 and receiving the update notification from the printer 10A. After the update instruction is sent to the printer 10A, it takes some time for the update of the firmware 42A in the printer 10A to complete. The above configuration can utilize the time until the update of the firmware 42A in the printer 10A is completed to update the service table 242.

Further, as illustrated in FIGS. 13 and 14, the SP server 200 sends a query signal to the printer 10B after sending the update instruction to the printer 10B. This configuration allows the SP server 200 to know that the firmware 42B has been completed in the printer 10B which does not have the automatic notification function.

Further, as illustrated in FIG. 12, the SP server 200 does not send a query signal to the printer 10A having the automatic notification function. The printer 10A having the automatic notification function automatically sends the update notification indicating the completion of the firmware 42A, without receiving a query signal from the SP server 200. This reduces processing load on the SP server 200 compared to a configuration where the SP server 200 also sends a query signal to the printer 10A having the automatic notification function. Further, the SP server 200 can appropriately switch between sending and not sending a query signal depending on whether the printer is a supported model.

### Advantageous Effects of Embodiment

As described above, the SP server 200 sends an update instruction to a printer (S20) in case the current version Vnow indicated by the version information received from the printer is less than a version threshold Vth for the printer (YES in S10 in FIG. 9). Then, after receiving an update notification or a response to a query signal from the printer (YES in S40 or YES in S62), the SP server 200 sends a flag change instruction to the printer (T260 in FIG. 12). Thus, the SP server 200 can send the flag change instruction to the printer at an appropriate time.

For example, it is conceivable that, for the firmware 42A in the printer 10A, only versions at or later than the version threshold Vth support the subscription service. Under such circumstances, if the current version Vnow is less than the version threshold Vth, the printer 10A cannot use the subscription service (i.e., the user cannot use the subscription service using the printer 10A). In view of this, in the embodiment, the SP server 200 sends an update instruction to the printer 10A (S20) in case the current version Vnow is less than the version threshold Vth (YES in S10 in FIG. 9). As a result, the firmware 42A in the printer 10A to which the update instruction was sent is updated to a version supporting the subscription service. Therefore, the user can use the subscription service using the printer 10A.

### Correspondence Relationships

The printers 10A, 10B are examples of “communication device”. The subscription service is an example of “service for the communication device”. The SP server 200 is an example of “server”. The service unavailable state is an example of “first state”. The current version Vnow being less than the version threshold Vth is an example of “predetermined condition”. The update notifications and responses to a query signal are examples of “completion information”. The service available state is an example of “second state”. The flag change instruction is an example of “change instruction”. The model names are examples of “device information”. The user ID is an example of “user identification information”. The address information, payment information, and plans are examples of “service information”. The memory 234 of the SP server 200 is an example of “memory”. The first confirmation screen SC2 illustrated in FIG. 4 is an example of “query screen”. The second predetermined period in S100 in FIG. 10 is an example of “predetermined period”.

T52 in FIG. 3 and T352 in FIG. 13 are examples of “receive version information”. S20 in FIG. 9, T220 in FIG. 12, and T370 in FIG. 13 are examples of “send the communication device an update instruction”. S40 in FIG. 9, S90 in FIG. 10, T258 in FIG. 12, and T422 in FIG. 14 are examples of “receive, from the communication device, completion information”. T110 in FIG. 5, T160 in FIG. 6, T260 in FIG. 12, and T430 in FIG. 14 are examples of “send the communication device a change instruction”.

(Modification 1) The “communication device” is not limited to a printer and may, for example, be a scanner, a copier, a multifunctional device, or a sewing machine.

(Modification 2) The “service” is not limited to the subscription service and may, for example, be an automatic shipping service, a charging service, or a remote printing service. In case the “communication device” is a sewing machine, the “service” may be an automatic shipping service for consumable articles used in the sewing machine.

(Modification 3) In the above embodiment, the SP server 200 is a physical server, however, the SP server 200 is not limited to a physical server and may be a virtual server or a virtual machine in the cloud. That is, the vendor need not prepare hardware for the SP server 200 itself, but may instead use an environment provided by an external cloud computing service. In this case, the vendor may realize the SP server 200 by preparing program(s) (i.e., software) for the SP server 200 and introducing it to the above environment. In another modification, the SP server 200 may be established on the internet 6 by a business operator different from the vendor.

(Modification 4) The SP server 200 may comprise multiple servers. For example, the SP server 200 may comprise a service server communicable with the terminal device 100, a device management server communicable with a printer, and a user information management server. In this modification, the user information management server stores user IDs and passwords. The device management server stores user IDs, serial numbers, model names, and tokens. The service server stores user IDs, address information, payment information, and plans. In this modification, the service server, the device management server, and the user information management server cooperate to implement the service subscription process illustrated in FIGS. 3 to 6. In this modification, the user information management server communicates with the terminal device via the service server (e.g., in T12, T14, T22, T26 in FIG. 3). Further, in this modification, the service server communicates with the printer via the device management server (e.g., in T50, T52 in FIG. 3, T110, T114 in FIG. 5, T160, T164 in FIG. 6, T220, T258, T260, T264 in FIG. 12, etc.). In this modification, the service server executes the processes illustrated in FIGS. 9 and 10.

(Modification 5) The “predetermined condition” may be the current version Vnow being within a predetermined version range.

(Modification 6) In FIG. 9, the SP server 200 may execute S22 before S20. In another modification, the SP server 200 may execute S22 in case of determination of YES in S40 or determination of YES in S62. In this modification, “store service information” may be omitted.

(Modification 7) The “device information” is not limited to a model name and may, for example, be a MAC address.

(Modification 8) The sequence from S30 to S62 in FIG. 9 and the process of FIG. 10 may be omitted. In this modification, the SP server 200 sends a flag change instruction to a printer in case a fourth predetermined period has elapsed since S20 in FIG. 9 was completed or a fifth predetermined period has elapsed since S22 in FIG. 9 was completed.

(Modification 9) The first confirmation screen SC2 illustrated in FIG. 4 may not include the check region 404. That is, the first confirmation screen SC2 may be the same as the second confirmation screen SC4 illustrated in FIG. 6. In this modification, “send query screen data” may be omitted.

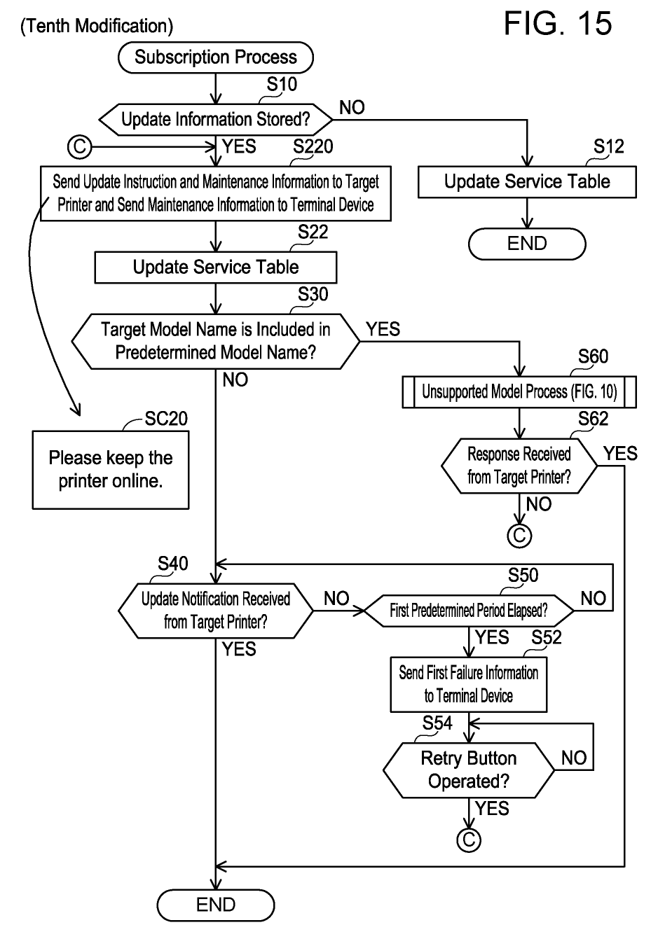

(Modification 10) Referring to FIG. 15, a subscription process executed in a modification 10 is described. Steps common to the embodiment are denoted with the same step numbers and description thereof is omitted.

As illustrated in FIG. 15, in case the CPU 232 makes determination of YES in S10, the CPU 232 sends an update instruction and maintenance information to the target printer in S220. In response to receiving the update instruction from the SP server 200, the target printer sends an FW request including the target model name to the FW management server 300. Further, in response to receiving the maintenance information from the SP server 200, the target printer displays an online maintenance screen SC20 on the display unit of the target printer. The online maintenance screen SC20 includes a message that requests the user to maintain the target printer online. The CPU 232 further sends maintenance information to the terminal device 100 in S220.

(Modification 11) In S20 in FIG. 9, the CPU 232 may send an update instruction and maintenance information to the target printer and may not send maintenance information to the terminal device 100.

(Modification 12) The CPU 232 may not send maintenance information to either the target printer or the terminal device 100.

(Modification 13) Under an environment where only printers having the automatic notification function are covered by the subscription service, S30, S60, S62 in FIG. 9 and the process of FIG. 10 may be omitted. In this modification, “send the communication device a query signal” may be omitted.

(Modification 14) Under an environment where only printers that do not have the automatic notification function are covered by the subscription service, S30, S40, S52 to S54 in FIG. 9 may be omitted. In this modification, the CPU 232 proceeds to S60 after completing S22.

(Modification 15) The “version information” is not limited to information indicating the version of firmware and may, for example, be information indicating an update date of firmware. In case the “version information” is information indicating an update date of firmware, the SP server 200 may store a threshold for update date.

(Modification 16) In the above embodiment, the steps illustrated in FIGS. 3 to 15 are implemented by software, however, at least one of the steps may be implemented by hardware such as a logic circuit. The software includes the programs 40A, 42A, 40B, 42B, 140, 142, 240, although this is merely an example.

What is claimed is:

1. A server configured to provide a service for a communication device, the server comprising:
a controller,
wherein the controller is configured to:
receive version information related to a version of firmware of the communication device from the communication device operating in a first state where the service is not available to the communication device;
in a case where the version information is received from the communication device and the version information satisfies a predetermined condition, send the communication device an update instruction for instructing an update of the firmware;
after the update instruction has been sent to the communication device, receive, from the communication device, completion information indicating completion of the update of the firmware; and
in a case where the completion information is received from the communication device, send the communication device a change instruction for changing a state of the communication device from the first state to a second state where the service is available to the communication device.

2. The server as in claim 1, wherein in a case where the version information is received from the communication device and the version information does not satisfy the predetermined condition, the update instruction is not sent, and
in the case where the version information is received from the communication device and the version information does not satisfy the predetermined condition, the change instruction is sent to the communication device without receiving the completion information from the communication device.

3. The server as in claim 1, wherein the controller is further configured to:
receive, from the communication device, device information related to the communication device;
receive, from a terminal device, user identification information for identifying a user of the communication device; and
in a case where the update instruction is sent to the communication device, store service information used for provision of the service in a memory by using the user identification information and the device information.

4. The server as in claim 3, wherein in a case where storing of the service information in the memory has been completed and the completion information is received from the communication device, the change instruction is sent to the communication device.

5. The server as in claim 3, wherein the controller is further configured to, in the case where the version information is received from the communication device and the version information satisfies the predetermined condition, send query screen data representing a query screen to the terminal device, the query screen querying a user whether the service information is to be stored in the memory and whether the firmware is to be updated,
in a case where the user selects that the service information is to be stored in the memory on the query screen, the service information is stored in the memory, and
in a case where the user selects that the firmware is to be updated on the query screen, the update instruction is sent to the communication device.

6. The server as in claim 1, wherein the controller is further configured to, in the case where the version information is received from the communication device and the version information satisfies the predetermined condition, send, to at least one of the communication device and a terminal device, state-maintaining information including information for requesting the communication device to maintain its state in an online state.

7. The server as in claim 1, wherein the controller is further configured to, after the update instruction has been sent to the communication device, send the communication device a query signal for querying whether the update of the firmware has been completed, wherein in a case where the completion information is not received from the communication device after a predetermined period has elapsed since the query signal was sent, the query signal is re-sent to the communication device, and
in a case where the completion information is received from the communication device after the query signal has been sent to the communication device, the change instruction is sent to the communication device.

8. The server as in claim 7, wherein the controller is further configured to receive model information indicating a model name of the communication device from the communication device,
wherein in a case where the model name indicated by the model information is a predetermined model name, the query signal is sent to the communication device after the update instruction has been sent to the communication device,
in a case where the model name is not the predetermined model name, the query signal is not sent, and
in a case where the model name of the communication device is not the predetermined model name, the communication device, upon completion of the update of the firmware, sends the completion information to the server without receiving the query signal from the server.

9. A method for controlling a server, the method comprising:
receiving version information related to a version of firmware of the communication device from the communication device operating in a first state where the service is not available to the communication device;
in a case where the version information is received from the communication device and the version information satisfies a predetermined condition, sending the communication device an update instruction for instructing an update of the firmware;
after the update instruction has been sent to the communication device, receiving, from the communication device, completion information indicating completion of the update of the firmware; and
in a case where the completion information is received from the communication device, sending the communication device a change instruction for changing a state of the communication device from the first state to a second state where the service is available to the communication device.

10. A communication system comprising:
a communication device; and
a server configured to provide a service related to the communication device,
wherein the communication device comprises:
a first controller configured to:
under a state where the communication device operates in a first state where the service is not available to the communication device, send version information related to a version of firmware of the communication device to the server,
wherein the server comprises:
a second controller configured to:
receive the version information from the communication device operating in the first state; and
in a case where the version information is received from the communication device and the version information satisfies a predetermined condition, send the communication device an update instruction for instructing an update of the firmware,
wherein the first controller of the communication device is further configured to:
after the version information has been sent to the server, receive the update instruction from the server; and
in a case where the update instruction is received from the server, execute an update process for updating the firmware; and
in a case where the update process is completed, send completion information indicating completion of the update of the firmware to the server,
wherein the second controller of the server is further configured to:
after the update instruction has been sent to the communication device, receive, from the communication device, completion information; and
in a case where the completion information is received from the communication device, send the communication device a change instruction for changing a state of the communication device from the first state to a second state where the service is available to the communication device,
wherein the first controller of the communication device is further configured to:
after the completion information has been sent to the server, receive, from the server, the change instruction; and
in a case where the change instruction is received from the server, change a state of the communication device from the first state to the second state.
